(19) United States
(12) Patent Application Publication
(10) Pub. No.: US 2006/0080278 A1
(43) Pub. Date: Apr. 13, 2006

(54) Automated paperless file management

(76) Inventors: Gerard D. Neiditsch, Paddington (AU); Richard C. Rous Verschoor, Fairlight (AU)

Correspondence Address: DICKSTEIN SHAPIRO MORIN & OSHINSKY LLP, 2101 L Street, NW, Washington, DC, 20037, US

(21) Appl. No.: 11/245,083

(22) Filed: Oct. 7, 2005

(30) Foreign Application Priority Data
Oct. 8, 2004 (AU) 2004-905852

(51) Int. Cl. G06F 17/30

(52) U.S. Cl. 707/1

(57) ABSTRACT

A computer-implemented electronic automated file management system and method for documents and email messages is disclosed. The system can send, receive, edit and access electronic documents. The document can be stored. When an email message is sent, suggested filing locating are presented such that a suggested filing location can be selected. The present invention automatically allocates access criteria based on a security model to allow external users to access appropriate documents.

### FIELD OF THE INVENTION

The invention is directed to a computerized file management system, and more particularly, to a system and method to assist in managing communications and documents.

### COPYRIGHT NOTICE

A portion of the disclosure of this patent document contains material which is the subject of copyright protection. The copyright owner has no objection to the facsimile reproduction by anyone of the patent document or patent disclosure as it appears in the Patent Office patent file or records, but otherwise reserves all copyright rights.

### BACKGROUND OF THE INVENTION

Professional service firms, such as law firms, typically retain detailed records of the communications and documents produced and received in relation to each engagement.

Typically, these communications and documents are stored in a hard copy paper file. For each engagement, a physical file folder would be created. Some organizations keep a master hardcopy file in a central file room, and those who wish to access the file may check it out of the file room. In other organizations, the person who is doing the most work on the engagement is responsible for keeping the file up to date.

For large, complex engagements, where a number of people are working together, having a single paper file is inefficient and often ineffective. More than one person may need access to parts of the paper file at the same time. Where different people are receiving communications or creating documents for that engagement, often the paper file will include many duplicates of the same document or will not include a document at all (because, for various reasons, the document never makes it to the file). To overcome some of these issues, some people working on the engagement will create their own personal “working” or “subfile”, thus creating more paper, but not ensuring the accuracy of any single repository of documents.

It is costly to maintain a paper filing system. This is particularly so in relation to the cost of physical storage—in many instances, the file must be stored for a period of time, such as ten years, after the engagement is complete. This often requires the renting of off-site storage locations, and involves costs in storing and accessing these historic files.

Professional service firms are document-intensive organizations. Examples of communications and documents stored on hard copy paper files include:
copies of letters and faxes sent and received;
notes of telephone calls and meetings;
internal memorandum and research notes;
copies of relevant primary materials, such as cases and legislation;
court papers and evidence;
contracts, and drafts of contracts;
copies of emails sent and received; and
drafts and copies of the above.

Correspondence on the file could include correspondence sent or received from the client, other people on the team, an opposing party, witnesses, other professionals providing assistance, investigators and government departments.

In recent years, there has been a significant increase in the volume of electronic documents and communications generated, sent and received in the course of providing professional services. (There has also been a slight decrease in physical mail and faxes being sent and received.) This is largely a result of the increased use of email. In effect, electronic format is replacing hard-copy. The use of electronic or digital storage means that it is possible to conceive of a “paperless office” in which a user need only make a hard copy of a document in specific circumstances, for example, where a signature is required, or where the person using the document has a preference to read or annotate a document in hard copy format, or where the document must be physically filed with a court or government office.

The move towards electronic communication and storage is supported by business generally because it increases the speed and efficiency with which documents can be handled, two attributes which are important to profitability. It is of vital importance to firms, including but not limited to professional service firms, such as law firms, and other organizations that they record, manage and track these communications and other documents both internally within the relevant organization and with external participants including, but not limited to clients, customers, suppliers, experts and advisers.

This ease and speed with which communications can be exchanged, and documents amended, has manifested itself by the distribution of large numbers of emails and electronic documents both within a firm and with the client and other external parties. Accordingly, individuals need to organize far greater numbers of documents than ever before, increasing the amount of administrative tasks they must carry out. For example, it is not unusual for an accountant, consultant or lawyer to receive more than 100 emails per day, which must be read, deleted if unimportant or stored in a logical and retrievable fashion. In practice it is difficult, time consuming and impractical. For example, lawyers and other professionals and their assistants must print all electronic documents and communications and place them on a hard copy file on a daily basis. Consequently, the development of an easy-to-use solution that supports electronic files is highly desirable.

There is a need for a system where all documents and communications relating to an engagement can be efficiently stored, managed and retrieved electronically in an organized and structured manner.

Document management techniques currently exist that allow electronic documents of different kinds to be brought together into a single repository. For example, Interwoven's Desksite system (a document management system used in the legal sector) allows documents created in applications such as Microsoft Word, Microsoft Exchange or Microsoft Excel to be collated and placed in a single logical structure according to the project to which the documents relate. Some of these currently existing document management systems are also able to record details of interactions other than what are typically regarded as “documents”, such as phone calls. (Most, though, began their development life as document-centric systems and are cumbersome in the way they record non-document interactions.) Some allow data about the document to be stored with the document, such as the document creator's name, or the time and date the document was created. This type of data about the document, which is itself a form of data, is sometimes called metadata—i.e. data about data.

However, beyond attaching some metadata to each document, much of which the user is called upon to supply, none of the currently existing document management techniques are directed at learning the document structure of each document they collect and store. There are several difficulties with this approach.

For example, imagine a particular email (“email A”) that is a reply to an email (“email B”) that was a reply to another email (“email C”) that was in reply to another email (“email D”); i.e. emails A, B, C and D form part of an “email chain”. By simply storing email A in an email system's native format, the currently existing systems cannot easily determine from email A who was the first sender in the email chain (i.e. the sender of email D). This may be important, for example, to a lawyer seeking to extract all email discussions initiated by a client. Text searching, of course, is possible. An advanced user might be able to construct a complex Boolean search query that looks through the text of the email conversation recorded in the email for the last “To:”. But this is cumbersome and presumes knowledge of Boolean search techniques in the user.

By way of another example, it is difficult to instruct currently existing document management techniques to search for all emails that have a Microsoft Excel document attached that is greater than 1 megabyte in size and which was created prior to 20 Jun. 2004 by someone whose surname starts with “Ver” or “Neid”. These emails, or their attachments, might need to be disclosed or discovered to another party in a litigation, for example.

The methods used to associate items with a project are also problematic. Filing items in the correct file is critical to a law firm's document management strategy.

The techniques used by currently existing document management techniques include “dragging and dropping” objects (such as emails in a document management system) to a location (such as an electronic folder), or highlighting items in a list and selecting (for example, from a drop down list) a filing location or project. The process of filing is typically done by the user after the document, communication or item has been created—or in the case of an email—sent or read. Some electronic solutions, such as Interwoven's Desksite system also enable an email to be filed on sending by “cc'ing” the email (that is, sending a carbon copy of the email) to an email address that corresponds with a project's file.

These existing electronic filing solutions often require an unacceptably high level of effort by the end user, do not sufficiently utilize the tools with which lawyers are familiar (e.g., Microsoft Outlook) and offer insufficient safeguards against inadvertent failure of the user to file project-related content or the inadvertent filing of content in the wrong location or file. They often make it difficult and time consuming to maintain a complete and unified view of the correspondence and documents between individuals and organizations. In particular, it is often difficult for a lawyer to tell if they or someone else on the project team has filed the document.

As a result, existing electronic file solutions have experienced relatively low uptake and high abandonment rates. For an electronic file solution to be viable in, for example, a law firm environment as a substitute for a paper project file, use by lawyers and support staff needs to be sufficiently high as to ensure that the necessary communications and documents are electronically filed.

Like many types of employees, lawyers, for example, operate in a high pressure environment and work under considerable time constraints. As a result, some lawyers have a relatively low threshold for administrative tasks. Any elimination or reduction in effort that can be achieved will increase the likelihood of lawyers actively using the system. Conversely, not every document that passes through a law firm must or even should be filed. Some emails, for example, are personal or are spam. If lawyers are presented with unnecessary filing processes, they may acquire the habit of circumventing the filing process. There is therefore a need for an electronic file management system that can discern, or allow the user in any business or industry to nominate which documents and communications should be subject to the filing processes implemented by that system.

With the increased prevalence of digitized information has come an increased reliance on the security framework within which this information is stored. However, managing who can access, and who cannot access, documents held in a document management system is very time consuming. In response, the common default security configuration for a document or an electronic file, in which “EVERYONE” can access “EVERYTHING”, is typically left untouched. There is a need for a system that is capable of understanding enough about a document that has been filed to make some decisions about who should be able to access that document.

Therefore there exists a need to redress these problems to provide an easy-to-use and low-effort electronic filing solution, with built-in safeguards to promote accurate, comprehensive and secure filing of content.

### SUMMARY OF THE INVENTION

The present invention relates to an improved automated paperless file management system.

While the present invention will be described with reference to a law firm, it should be understood that the invention is not so limited but can be used by any entity or individual that wishes to keep organized and structured electronic records. This includes, but is not limited to professional services organizations, accounting firms, consulting firms and engineers, insurance companies, financial services businesses, hospitals and doctors, and government departments.

According to the present invention, an electronic file is created for each project. Herein, the term “project” is used to signify a group of work activities that are related. A project could be, for example, a matter, an engagement, a litigation, a dispute, a deal, a case or an opinion.

Electronic documents can be stored in the electronic file. Herein, the term “document” includes, for example, letters, emails, voicemail messages, spreadsheets, facsimiles, notes, memos, contracts, calendar appointments and diary notes, “to do” and other checklists, papers, licenses and permits, research and other reports, documents created using a word processor, scanned documents, photographs, sound recordings, drafts of all the above, and all other documents, whether originating in electronic or hardcopy form. The invention is independent of the software application used to create, send or receive the document.

The present invention is an automated paperless file management system with one or more of the following features:

(a) for a document filed using the system, programming logic for modeling the structure of the document—that is, of understanding the structure of the document, of distinguishing between the properties of the document, and for supporting support complex searches based on properties of the document;

(b) a user interface feature in which the user is prompted to file a document upon the occurrence of one or more trigger events;

(c) a user interface feature in which a constructed subset of the population of electronic files known to the system are presented to the user as suggested filing locations for the document;

(d) a user interface feature by which the user is informed whether a particular document has been filed or not;

(e) a user interface feature by which a user may nominate the nature of a document—for example, whether a document is of a personal or business nature—and hence whether the system's filing features are to be activated;

(f) a security feature by which the system implies the appropriate security model for a document based on the system's understanding of the document; and

(g) a feature by which documents are presented to the user as being stored within or by the program to which a user interface relates, but are in fact stored elsewhere (referred to in this application as “masquerading”).

These features will be described, in turn.

Structured searching amongst filed documents

The present invention views each document as an item (sometimes called an object) with one or more component parts (sometimes called a property or field). By understanding the structure of each class of document, the present invention is able to identify a given document as being of a particular class of documents. The present invention then applies its understanding of the structure of that document class to separate out the document's properties. (“Understanding the structure” of a document in this specification includes knowledge of the structure of the document and an ability to distinguish between the properties that make up that structure).

For example, the present invention, having identified an item as an email, and applied its understanding of an email's structure, might identify and extract the following properties of a particular email (for example, email A from the example above):

(a) “Participant” with participant type from (i.e. the sender);

(b) “Participant” with participant type of any or all of to, copy, or blind copy (i.e. the recipients);

(d) “Content” (i.e. the message content text);

(e) zero or more “EmailAttachments”; and

(f) email A's status within the email chain of which it is part (an email chain is an example of a “Conversation” that is referred to in FIG. 8).

An email “id” (sometimes called an index or key field) might also be added to the email's record. Importantly, too, a “project” or similar field might later be added to associate the email with one or more projects.

Each attachment may itself be a document and may have its own fields or properties that the present invention would separately identify. Similarly, the sender and receivers are people who may have recordable properties (such as a name, email address, and phone number) and who may be modeled as objects.

A reader familiar with computer programming methods will understand that this approach, in which documents, people, attachments and so on are represented as electronic objects, each with their own fields or properties, lends itself to being implemented by an object-oriented programming approach. Object-oriented programming is a popular programming method in which real-life things are modeled as “objects”. Objects are categorized into “classes”. Each object is an instance of a class. A class is like a template—it forms the skeleton of each object that is an instance of it (i.e. is cut from that template). For example, in a representative embodiment, there might be an “email” class, which has the properties of the type described for email A above. Each email object, for example email A, is an instance of this email class, and therefore will have the properties of the email class.

While the current invention will be described using object-oriented terminology, it should be understood that the invention is not so limited and could be implemented using any programming method or technique that is capable of understanding, applying and manipulating data structures, including but not limited to data structuring techniques such as XML (eXtensible Markup Language), and procedural languages such as C.

Having separately identified the properties of a document, and of any documents embedded in that document (such as an attachment in an email, or a spreadsheet document in a document prepared with word processing software), the representative embodiment might then store each of these properties in one or more databases (collectively referred to in this specification as a “database”). The database might be a relational database, or object-oriented database, or any other structured storage system. Large properties (which may themselves also be objects), such as .bmp files or .pdf files, or large spreadsheet files, might be referenced in the database but stored outside the database on, for example, a separate file server. This feature is referred to in this specification as masquerading.

Enabled by this structure-centric approach to managing documents, the present invention enables searching functionality not previously available in the prior art solutions.

By understanding the structure of the documents it manages, the present invention is able to support complex searches based on properties of any of the documents of which it has visibility.

In the example given above involving emails A, B, C and D, a user might want to search for all email chains that are initiated by person X. This search is made simple for the user to construct and for the system to execute by the current invention. The representative embodiment stores, for each email in the email chain, the properties or fields set out for email A above. By reference to the “Conversation” with which email A is associated, the representative embodiment is able to trace through the email chain to find the email “id” property of the first email in the email chain. Having identified email D, its sender is then easily identified, since it is stored as a property of email D. If, for example, the database in the representative embodiment is a relational database, the properties of each document might be stored in a series of different but related tables. The email “id” property of email D would link all the properties about email D together, enabling the database to quickly extract, by reference (for example) to the “Participant” property with type from, the sender of email D.

By way of further example, the present invention supports queries such as a request for:

(a) a fax or letter dated 1/1/0x sent by participant X to participant Y on 2/2/0x;

(b) a fax on 2/2/0x between participants X and Z;

(c) a cover page of a fax directly related to MS Word document N;

(d) a letter contained in a fax directly related to MS Word document M; and

(e) a letter dated 1/1/0x between participants X and Y.

The present invention can also be used to perform traditional content searching (sometimes called text searching) in addition to, or in conjunction with, the structured searching described above. For example, the present invention allows the user of the present invention to search for the word “share sale” in all email attachments of emails sent by person X to person Y between 1/1/0x and 1/2/0x.

Furthermore, because of the centralized storage of filed documents, the present invention also allows multiple users to access the same documents concurrently (subject, of course, to the user's permissions, referred to later, and to version control features commonly used by document management systems).

User interface features to prompt the user to file, to suggest filing locations, and to identify unfiled documents

The present invention also offers an improvement over prior art filing techniques, particularly regarding the user interface and its role in helping the user in the filing process. The user interface of a computer program is the means through which a user interacts with that program. The interface supports a dialogue between the user and the computer program, allowing the user to control the computer program, while providing feedback to the user as to the results of their actions. It is commonly manifested as a set of on-screen buttons, icons, commands, graphical display formats, and other objects provided by the computer program to allow the user to communicate with the computer program.

In the representative embodiment, the user can create, view, retrieve or modify the documents stored in the database via a user interface. The user interface might, for example, be the user interface of a custom-built user client application, or of a web browser client, or of an off-the-shelf application such as Microsoft Exchange or Word. In fact, one of the advantageous features of the present invention is that it supports the user interface of off-the-shelf applications that are commonly used by users. This means that the present invention can leverage existing software features with which the user is already familiar. For example, the present invention's user interface might take the form of Microsoft Outlook's user interface, supplemented with the present invention's buttons, icons and other user interface objects specific to the present invention. Electronic files might, for example, take the form of “public folders” in Outlook's native user interface. Similarly, and by way of non-limiting example, Outlook's native rules and wizards functions might be used in conjunction with the present invention's features to sort, organize and manage documents such as emails. In this example, a user's Microsoft Outlook user interface might display:

(a) in the user's Outlook Inbox, all emails addressed to the user's mailbox (to which the user would have access using native Outlook functionality); and

(b) in an Outlook public folder relating to a project, all documents that have been filed for the project using the present invention and which are therefore stored or referenced in the system's database (subject of course to the user having the appropriate security permissions).

This is in contrast to most prior art systems, for which separate client programs have been written, albeit written to launch within the Microsoft Outlook frame. Prior art systems tend to provide an ability to move the item from the Inbox to the system, rather than to let the item remain and exist in the Inbox (or any other mailbox or Outlook folder). With the present invention, changes to details of that item (be it by another user or within another interface) will be reflected on any instance of that item in Outlook.

Moreover, a user might access the documents via more than one user interface. For example, the user might view documents of all types in the user interface of an email program such as Microsoft Outlook, but use a word processing program such as Microsoft Word to modify documents that take the form of text-based documents.

The present invention, among other things, introduces to this user interface several advantageous features directed at filing efficiency. In particular, the user interface of the present invention presents to the user a list of suggested filing locations for a document. This can be done upon a range of trigger activities—for example, when an email is sent, when an email is read and closed, or when a document is created and closed.

Using an email as an example document, when the email is sent, the user may be prompted to file the email (that is, at a data level, populate the “project” field for example, and at a user interface level, make the email appear in the project's electronic file). Then, to reduce the administrative burden on the user, a list of likely candidate electronic files are presented to the user. In the representative embodiment, the list of electronic files presented to the user as likely filing locations might be selected based on one or more of the following factors:

(a) electronic files to which the user is assigned;

(b) electronic files to which the user has recently filed documents;

(c) electronic files to which earlier parts of an email chain have been filed;

(d) electronic files to which other documents, of which the document's participants were also participants, have been filed (e.g., for an email, the electronic files to which other emails, sent by the email's sender to one or more of the email's recipients, have been filed); or

(e) electronic files to which an attached item are filed.

The reader will understand that similar factors could be easily developed to reflect a business' work patterns.

Each of these factors may be given a weighting by a weighting algorithm, in accordance with predetermined weights, to estimate each file's relative likelihood of being the correct filing location (referred to in this specification as the file's “assessed relevance”). The weighting algorithm might be used, for example, to arrange the list of files presented to the user in descending order of assessed relevance.

Thus, the user is presented with the projects that are most likely to be the appropriate filing locations (subject to electronic file permissions), making the filing process faster and less subject to error than, for example, the “drag and drop” method that is natively available in programs such as Microsoft Outlook. This technique of the present invention also enables users to file a document in more than one project. This is difficult with the “drag and drop” method. (The user will understand, though, that the native features of a user interface on which the present invention is built, such as “drag and drop”, are still available to users.) Moreover, because documents are stored or at least referenced centrally in a database from which all users draw upon and contribute to, documents need only be filed once.

The present invention also incorporates a “filed/not filed” feature. In the representative embodiment, an icon or similar construct in the user interface is used to show the user whether a document selected by the user in the user interface has been filed, whether by that user or another user. Similarly, the user might sort documents based on the status of the “filed/not filed” icon. This feature of the present invention is made possible by:

(a) the system's visibility of each document relating to a project, regardless of whether the document is filed by, for example, user X or user Y (or any other member of the project team); and

(b) using the structured information available about a document to identify whether that document has been filed into one or more folders.

Because the “filed/not filed” button and icons provide a simple and quick method for the user to determine whether documents have been filed, they enable the user to easily identify documents that they have inadvertently failed to file. As an added feature, the present invention includes a technique by which, for a document showing as having been “filed”, the project to which the document has been filed is shown in the user interface when the user selects the document. Amongst other benefits, this enables the user to quickly identify whether the document has been filed correctly.

User interface feature by which user nominates the nature of a document

The user interface of the present invention is also enhanced by a feature that enables users to nominate the nature of the document. For example, a user may nominate that an email is of a personal rather than of a business nature. For documents that are personal, the triggers that would normally prompt the user to file the document (for example, upon an email being sent) are disabled. The reader will understand that other variations on this technique are possible—for example, there might instead be 3 categories of documents—personal, business and confidential. For confidential documents, the present invention might prompt the user to file the document but might automatically mark the document as being subject to restricted access. Defaults, of course, could be set—user X's documents might default to business, while user Y's documents might default to personal.

Implicit security permissions

Understanding the structure of documents, such as emails, also enables the present invention to provide more sophisticated security models. Under the traditional security model, the system has a list of specified users who have permissions in relation to a document or folder of documents (e.g., READ permission, WRITE permission etc). The list of permissions for a particular document or folder typically have a default setting (e.g., the EVERYONE can READ and WRITE, or NOBODY can READ or WRITE), which are then modified by system users such as the system administrator or the document's owner. Typically, permissions can also be inherited by documents copied from a document, or propagated to documents within the folder. These traditional permissions will be called “explicit permissions” in this specification.

Explicit permissions require system users to consider, and implement, a permission model. Although traditional systems are sufficiently “intelligent” to presume that documents within a folder are likely to require the same permissions as the folder, or that documents copied from a document are likely to require the same permissions as the source document, the system's ability to infer the required permission list for a given document is otherwise very limited. This means that businesses either:

(a) invest a lot of human labor, and therefore administrative overhead, in maintaining permission tables that properly reflect who the business wants to access each document, and who the business does not want to access each document; or

(b) allow permissions to be loose (e.g., EVERYONE can READ and WRITE to every document), and accepts the business risk that accompanies that decision.

The cost of option (a), and the risk of option (b), is compounded in the context of an extranet. An extranet is a network of computers that a business exposes to a select set of customers or business partners (e.g., via the Internet) to allow those partners or clients to share access to a select subset of the business' online resources. For example, in the case of a law firm's extranet, the law firm might want to publish to a client, but no one else, all the advices the law firm has given that client. The inherent difficulty with prior art extranets is that the extranet owner needs to pay someone to collect, from the masses of documents held on the owner's computer systems, the documents that are to be published to each client or partner and set appropriate permissions on each document. If insufficient resources are devoted to this task, typically either:

(a) insufficient documents are made available on the extranet to give it a “critical mass” such that it becomes a tool that clients use and therefore warrants the further funding necessary to add further documents; or

(b) documents are made available on the extranet with inappropriate permissions, and to too many people, resulting in a loss of trust between the client and the extranet owner.

To overcome the administrative burden of properly setting permissions on documents, the present invention supports implicit methods that are more capable of inferring what permissions should be attached to each document. In particular, the present invention may include the step of automatically inferring, and then applying, security permissions to documents based on the involvement of the user in the document. In this specification, these will be called “implied permissions”.

For example, a user may be allowed to see only those filed emails of which he or she the sender, or one of the recipients. By way of further non-limiting example, the present invention supports the following other security models:

(a) the sender and all recipients of an email can view, but not write to, an email document; no other users may view the email except the manager responsible for the project;

(b) if a user is a party to a letter sent by fax, the user will be able to view the fax; and

(c) a user who has once edited a document will be able to view the text edited by the user,

in each case either in addition to or in substitution of any explicit permissions that may have been assigned to the document.

In the context of an extranet, this feature is very advantageous in that it allows extranet owners to quickly and easily deploy large numbers of documents to the extranet, in the knowledge that they will be secured by implicit permissions (in addition to, of course, appropriate network- and host-level security).

Thus, critical mass and currency can be achieved for the extranet with minimal cost. For example, all of the emails for a particular matter can be posted to the extranet with implied permissions attached. As a result, each sender and receiver of a particular email will have access via the extranet to that email. This will not expose the email to anyone who would not have, or previously have had, access to the email, and so will not represent incremental disclosure. The advantage, of course, is that the extranet-exposed system will represent a single repository of the emails relating to a matter, accessible both via the business and the business' client.

### IN THE DRAWINGS

The preferred embodiments of the present invention will be further described with reference to the following non-limiting drawings and description wherein:

FIG. 1 contains a diagrammatic representations of one embodiment of the user interface of the present invention. In this embodiment, user interface features of the present invention are added to the user interface of Microsoft Outlook. FIG. 1 further shows, in the user's Inbox, a selected document that has not been filed.

FIG. 2 is a screenshot showing an embodiment of the feature of the present invention by which the user is provided likely electronic files to which a document might be filed.

FIG. 3 is a screenshot showing another embodiment of the present invention, a selected document in the user's Inbox that has been filed.

FIG. 4 is a screenshot showing, in the user interface of an embodiment of the present invention, a selected document in an electronic file.

FIG. 5 is a screenshot showing an embodiment of the feature of the present invention by which the user nominates the nature of a document.

FIG. 6 is a flowchart illustrating the process by which a user of an embodiment of the present invention ascertains whether a document has been filed, and if so, the project to which that document has been filed.

FIG. 7 is a flowchart illustrating the process by which a user of an embodiment of the present invention files a document.

FIG. 8 is the system topology in an embodiment of the present invention.

FIG. 9A-9B illustrate the conceptual data model in an embodiment of the present invention.

### DETAILED DESCRIPTION

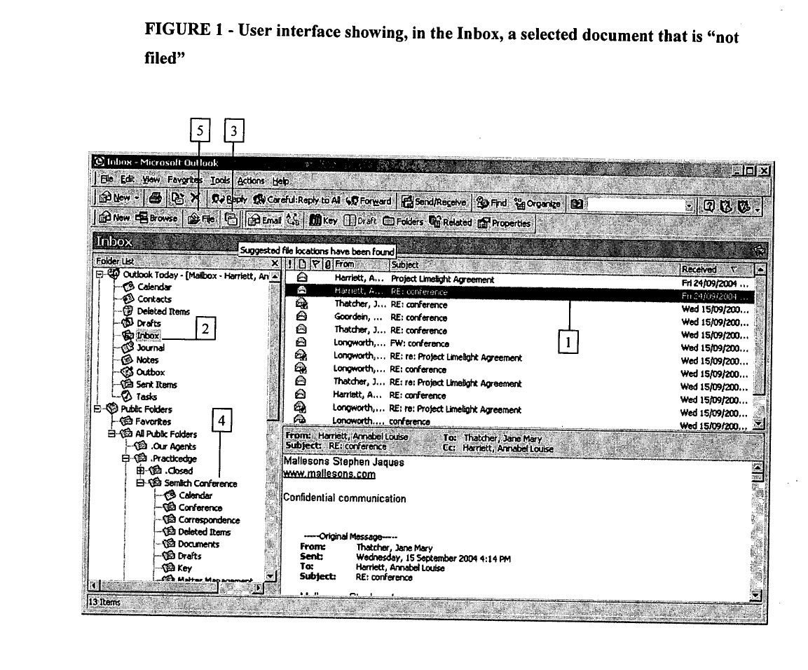

FIG. 1 is a screenshot of one embodiment of the user interface, in which several of the user interface features of the present invention are embodied in the Microsoft Outlook user interface. The drawing illustrates how the present invention might integrate with existing or future software applications with which users are familiar. However, the present invention is not limited only to the Microsoft Outlook interface, but may be employed in any other known interface.

Selected document 1 is shown in Inbox 2. Inbox 2 contains email documents that have been sent by email to the user's email address and are stored as emails in the traditional manner (i.e. either on an email server or in the user's local email archive).

“[f]iled/not filed” icon 3 shows one example of how the “filed/not filed” feature can be incorporated into the toolbar displayed in the interface of the user. In this screenshot, by taking the form of a “shadowed folder”, the “filed/not filed” icon indicates to the user that selected document 1 is not filed but suggested electronic files have been identified by the system. The user is thus alerted that this document should potentially be filed and that the system can help by providing likely electronic files. If selected document 1 was not filed but the system had not been able to identify suggested electronic files, “filed/not filed” icon 3 might instead, for example, take the form of a “crossed” folder.

Electronic file 4, titled “Semlich Conference”, shows an example of how electronic files might be displayed to the user in the present invention. In this embodiment, electronic file 4 takes the form of a “public folder” in Microsoft's Exchange/Outlook architecture, and is shown in the user interface as such.

To file selected document 1, (for example, to “Semlich Conference” electronic file 4), the user may either:

drag and drop selected document 1 to “Semlich Conference” electronic file 4 using native Microsoft Outlook functionality; or

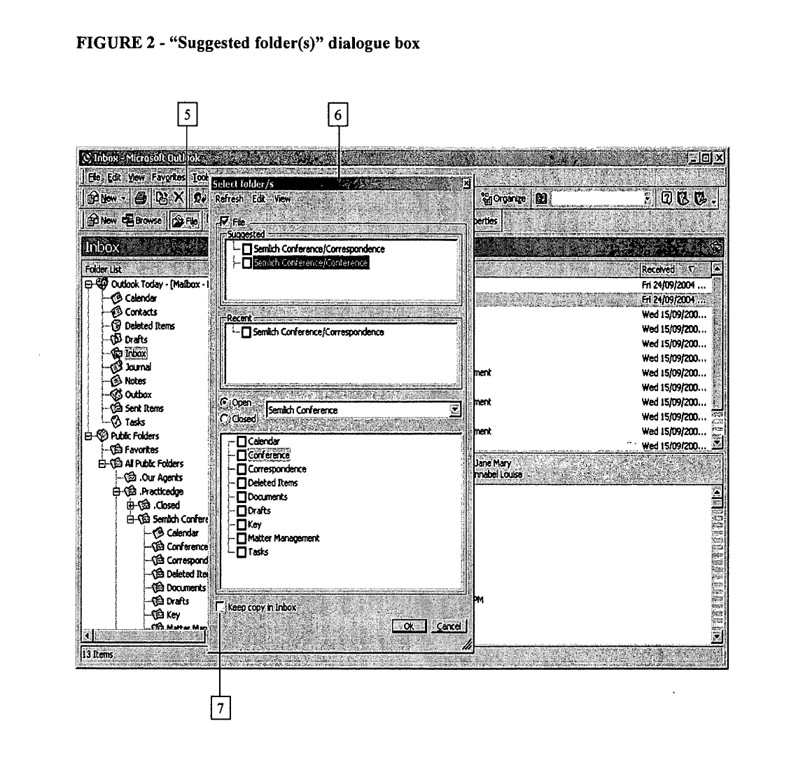

activate the suggested filing location feature by, for example, clicking on “file” button 5. The suggested filing location feature, and the other ways it may be triggered, are discussed below in the context of FIG. 2.

FIG. 2 is a screenshot showing an embodiment of the feature by which the user is provided suggested electronic files to which a document might be filed. In FIG. 2, this feature takes the form of “Select folder/s” dialogue box 6. “Select folder/s” dialogue box 6 may be activated in one of several ways:

by opening an existing document (for example, an email or spreadsheet document) or by creating a new document, and then clicking on “file” button 5;

by highlighting one or more documents in the user interface, for example, one or more emails in inbox 2, and then clicking on “file” button 5 (as was the case in the screenshot shown FIG. 2, as contemplated in the 2nd bullet point in the paragraph above); or

by sending, forwarding or replying to an email that is not marked as being of a personal nature.

This third alternative, which automatically prompts the user to file an email on sending, encourages and reminds the user to file business emails, thus increasing the incidence of filed emails. Further, because it prompts the user in the course of sending, forwarding or replying to an email—and in the same interface enables the user to file the email by selecting the relevant folder(s)—the user does not need to file the email as a separate task or activity, thus minimizing time and effort for the user.

The reader will understand that a wide variety of other implementations of this technique might exist, particularly in other types of software applications. For example, in a user interface that builds upon a word processing application, such as Microsoft Word, the present invention might include a “File and Save” button (which might substitute, in the context of a Microsoft Word-based user interface, for “file” button 5). This method of filing enables the user to simultaneously save and file a document (in this case, a word processing document). This eliminates the need for the user to file the document as a separate task.

As can be seen in FIG. 2, once activated, “Select folder/s” dialogue box 6 will display a list of electronic files. The user may select an electronic file or multiple electronic files from the list displayed in the dialogue box. The user selects one or more electronic files by clicking in the tick box adjacent to the folder(s) that the user wishes to select. Once the desired electronic file(s) have been selected, the user clicks on the OK button on the dialogue box. Clicking on the OK button closes the dialogue box. The relevant document(s) will then be copied or moved to the electronic file(s) selected by the user. As can be seen in FIG. 2, the user may also elect to keep a copy of the document in the Inbox (in addition to the copy kept in the selected electronic file(s)) by clicking in tick box 7 titled “Keep copy in Inbox”. Of course, if the folder(s) displayed to the user for selection are not appropriate, the user may select a different electronic file.

Which folders are offered to the user in “Select folder/s” dialogue box 6 may be determined in accordance with the factors listed above in this specification. In the embodiment shown in FIG. 2, the electronic files that are offered to the user fit the following criteria:

(a) electronic files to which earlier parts of an email chain have been filed—displayed in FIG. 2 as the “Suggested” electronic files;

(b) electronic files to which the user has recently filed other documents—displayed in FIG. 2 as the “Recent” electronic files; and

(c) electronic files of the project to which the user is assigned, displayed in FIG. 2 in a drop-down box.

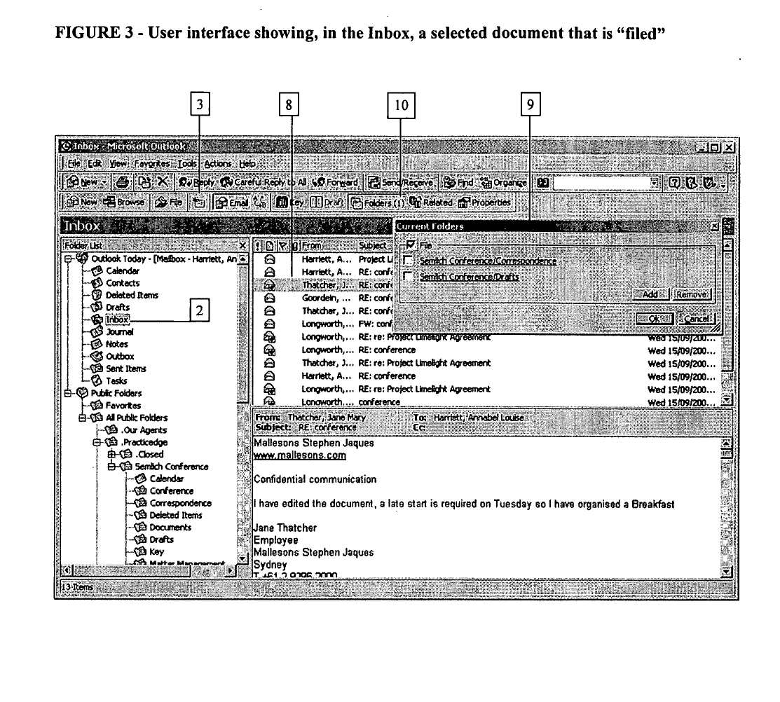

In FIG. 3, selected document 8 appears in Inbox 2 in the user interface of one embodiment of the present invention. In contrast to selected document 1 in FIG. 1, selected document 8 has been filed. The user is informed of this by “filed/not filed” icon 3 taking the form of a “sparkling” folder. The user is thus advised that they need not re-file the document, unless they wish to file the document in a different or an additional electronic file.

“Current Folders” dialogue box 9 in FIG. 3 also shows another feature of the present invention. “Current Folders” dialogue box 9 tells the user to which electronic files selected document 8 has been filed. The appearance of “Current Folders” dialogue box 9 might be triggered, for example, by the user selecting “Folders” button 10.

This method of identifying the electronic file(s) to which a document has been filed is quick and simple to use. This allows the user to easily identify whether the an electronic document has been filed to the folder(s) relevant to the current user.

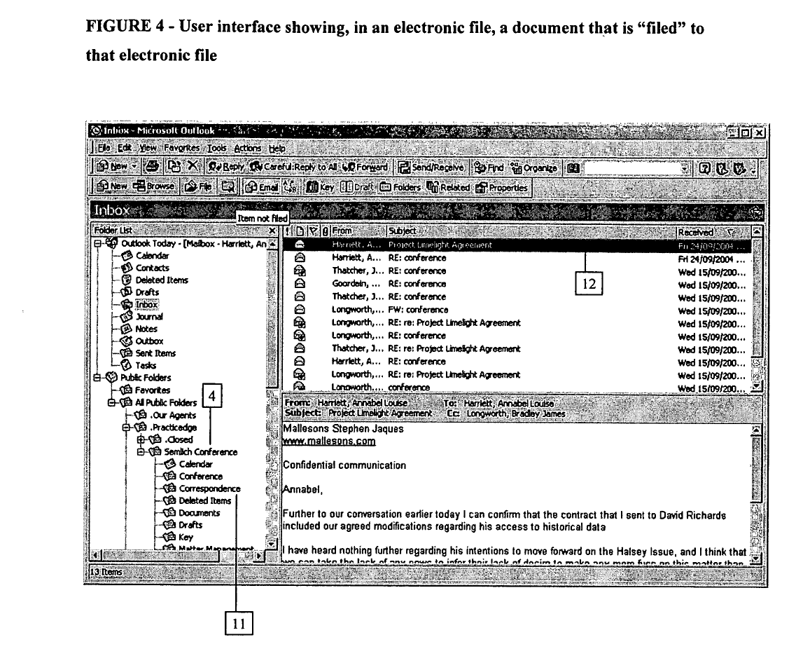

FIG. 4 is a screenshot of, in one embodiment of the present invention, the contents of “Correspondence” electronic subfile 11, which is part of “Semlich Conference” electronic file 4. Selected document 12, as is the case for the other documents shown in “Correspondence” electronic subfile 11, appears in “Correspondence” subfolder 11 because that is the electronic file (in this case a folder within a folder) to which selected document 12 was filed.

As can be seen in FIG. 4, in this embodiment of the present invention, “Semlich Conference” electronic file 4 and “Correspondence” electronic subfile 11 take the form of “public folders” in the Microsoft Exchange/Outlook architecture and are displayed to the user via the Microsoft Outlook user interface.

Documents shown within “Semlich Conference” electronic file 4 and “Correspondence” electronic subfile 11 may be stored in the native email system (in this case, Microsoft Exchange and Microsoft Outlook) as links. The digital content representing the documents (to which the shortcuts or links refer) may, in fact, be stored in the present invention's database, file server or elsewhere. This is a form of “masquerading” described earlier in the specification.

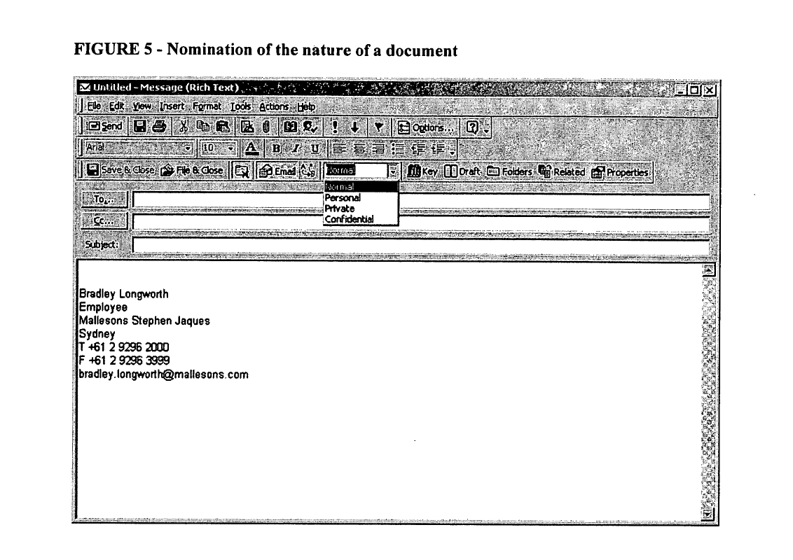

FIG. 5 is a screenshot showing an embodiment of the feature of the present invention by which the user nominates the nature of a document. If a document is nominated by the user, for example, as being of a “personal” nature, “Select folder/s” dialogue box 6, as shown in FIG. 2, will not be automatically activated when the user sends, forwards or replies to an email. Users are therefore prompted to file only business-related emails in the course of sending, forwarding or replying to business-related emails.

This technique recognizes the different purposes or sensitivities associated with emails in the business environment. This technique enables an email to be assigned the status of normal, personal, private or confidential.

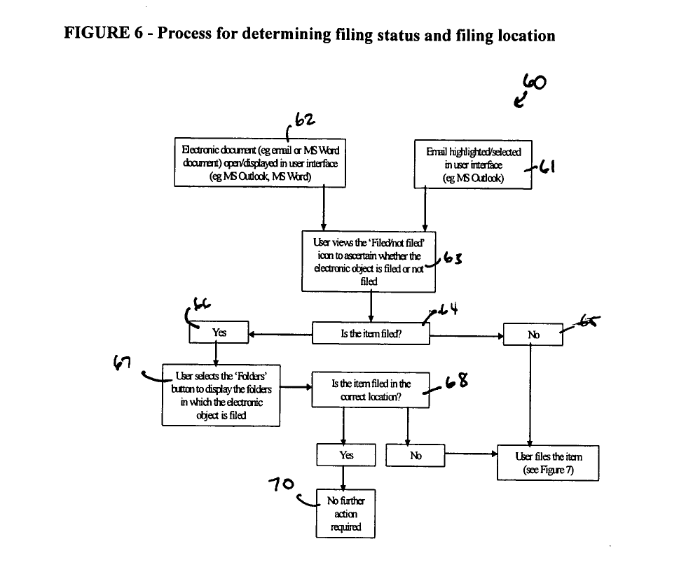

FIG. 6 is a flowchart illustrating the process 60 by which a user of an embodiment ascertains whether a document has been filed, and if so, the project to which that document has been filed.

First, the user can highlight 61 or display 62 an item in the interface of the user. In the representative embodiment, the user interface may be Microsoft Outlook's or Microsoft Word's user interface although any other interface can employ the feature described by the present invention.

Secondly, at step 63 the user will determine from an icon such as “filed/not filed” icon 3 whether the displayed or highlighted item has been filed. In the representative embodiment, “filed/not filed” icon 3 is displayed as an icon on a toolbar in Microsoft Outlook or Microsoft Word. In the representative embodiment, if the selected item has been filed, “filed/not filed” icon 3 will show a “sparkling” folder. If the item has not been filed, the icon will display a “crossed” folder.

Thirdly, if the item has not been filed 65 the user can trigger a dialogue box such as “Suggested folder/s” dialogue box 6 (as described above in FIG. 2) and file the item. If the item has been filed 66 the user can select a button such as “Folders” button 10 at step 67 on the toolbar to display the project(s) to which the item has been filed. If the item has been filed in the correct location 68 for the purposes of the current user, he or she need take no further action at step 70.

Fourthly, if the user wishes to file the item in an alternative location or project, the user can trigger a dialogue box such as “Suggested folder/s” dialogue box 6 (as described above in FIG. 2) and file the item to the desired electronic file(s).

All these steps can be performed simply by the user within the user interface of commonly used applications such as Microsoft Outlook and Microsoft Word, and whilst the user is working on or viewing the relevant item(s).

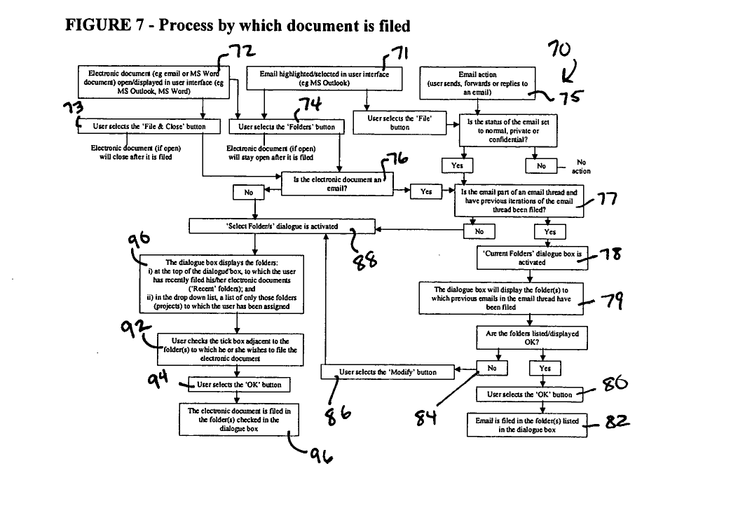

FIG. 7 is a flowchart 70 illustrating the process by which a user of an embodiment files a document.

First, the user can highlight 71 or display 72 an item in the interface of the user. In the representative embodiment, the user interface may be Microsoft Outlook's or Microsoft Word's user interface.

If the item is open in the application, the user can select the “File and Close” button at step 73 on the toolbar of the user's application. This will simultaneously close the item and trigger a dialogue box such as “Suggested folder/s” dialogue box 6 (as described above in FIG. 2).

Alternatively, where an item is selected in the user interface (e.g.,, an email is highlighted in the user's Outlook Inbox) or an item is open (e.g.,, a Word document is open in Microsoft Word) the user may select a button such as “Folders” button 10 at step 74. Selecting the “Folders” button will trigger a dialogue box such as “Suggested folder/s” dialogue box 6 (as described above in FIG. 2).

Alternatively, the user may send, forward or reply to an email at step 75. If the status of the email is set to a status other than personal, the selected folders box will be triggered on sending, forwarding or replying.

A dialogue box such as “Suggested folder/s” dialogue box 6 will present a number of suggested folders or projects (as described above in FIG. 2). The user may select an electronic file or multiple electronic files from the list displayed in the dialogue box at step 90. The user selects an electronic file or folders by clicking the tick box adjacent to the folder(s) that the user wishes to select at step 92. Once the desired electronic file(s) have been selected, the user clicks the OK button on the dialogue box at 94. Clicking the OK button closes the dialogue box and moves or copies the relevant item to the electronic file(s) selected by the user at 96.

Alternatively, if the item is an email 76, and the email is part of an email chain, and previous iterations of that email chain have been filed 77, the user may—in all the scenarios described above—be presented with a list of those folders to which the previous iterations of the email have been filed 78. This list of folders is displayed in a dialogue box called the ‘Current Folders’ dialogue box. The current folders dialogue box will be displayed instead of the selected folders dialogue box at step 79.

If the user wishes to file the item to the folder displayed in the current folders dialogue box, the user clicks the OK button on the dialogue box at step 80. This will close the dialogue box and move or copy the relevant item to the folder(s) displayed in the dialogue box at 82.

If the user wishes to file the item to a folder other than that displayed in the current folders dialogue box at 84, the user selects the Modify button at step 86 on the dialogue box. Selecting the Modify button will trigger the selected folders dialogue box (as described above) at 88.

In one embodiment, the present invention is provided as a software program in electronic form for use on any conventional computer or computer system.

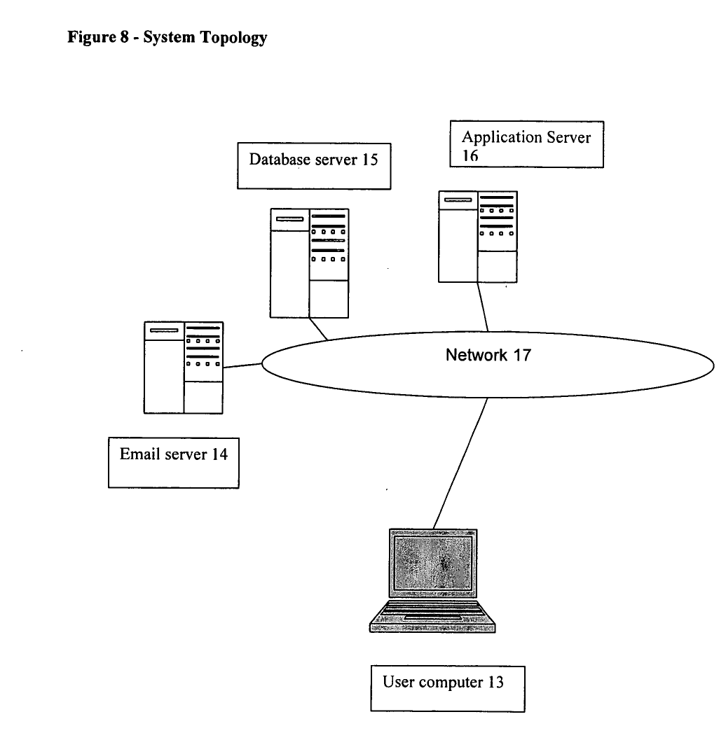

In another embodiment the present invention is implemented in a computer system shown in FIG. 8, comprising both hardware and software. In a representative embodiment, the present invention can be implemented in a client-server network of computers, each running computer programs. Client-server architectures are well known in the art and are suited to the functions of the present invention. Any multi or single client server configuration is contemplated. User computer 13, including but not limited to a personal computer, can run a user email client program, such as but not limited to Microsoft Outlook and document authoring software, including Microsoft Word, each configured in accordance with the present invention and with extra “add-in” programs installed. User computer 13 is coupled to network 17. The network 17 can be, for example, a local area network, a wide area network or the Internet. Also coupled to network 17, for example, and by such coupling connected to user computer 13, is:

(a) email server 14, such as a Compaq Intel server, which runs an email server program, such as Microsoft Exchange on a Microsoft Windows Server operating system;

(b) database server 15, such as a Sun Sparc machine, which runs a database program, such as Oracle on a Unix operating system; and

(c) application server 16, such as a Sun Sparc machine, which hosts the system's business logic implemented, for example, using Java programs running in a J2EE environment on a Unix operating system.

An add-in to the email client program running on user computer 13 modifies the email client program's functionality such that when the user clicks the “send” button on the user interface presented by the email client program, a window is shown to the user that includes the suggested filing location, using the criteria set out above.

When the user selects a filing location, HTTP calls or similar networking technologies are used by user computer 13 to send the email to application server 16, and to communicate the user's filing location selection (also referred to in this specification as an electronic file). Using the object modeling techniques described above, application server 16 identifies the received object as an email, and deconstructs the email down into its constituent parts (e.g., attachments, the name and email address of the recipient, the name and email address of the sender, the text component, any attachments, the conversation of which the email is part etc). Each constituent part is then communicated to database server 15, for storage on the database program running on database server 15.

To enable reconstruction of the email when and if it is recalled by a user, a field is attached to each constituent part to identify each part as belonging to that email. Such database technology is well-known in the art.

Having broken each email down into its constituent parts, the database program can now be queried for each email that has, as its attachment, Word document “x”. Thus the queries of the type described in this specification are enabled by the present invention.

Also attached to each email record in the database is a “project” field, or similar, identifying which filing location the user selected to file the email in. This, and the techniques described above, enable the system to query the database for the filing locations (e.g. filing locations [represented in the “project” field] to which a given user has most often filed, or the filing location other emails in the email conversation have been filed to, or the filing locations to which recipients of the email have recently filed to). Thus, the system is able to populate the list of suggested filing locations for the email when the user clicks the “send” button, as described above.

Having deconstructed the email and then commanded database server 15 to file the email in the selected filing location, application server 16 then forwards the email to email server 14 for sending to the email's intended recipient.

The reader will understand that this process can equally be applied to other types of documents, other than emails. For example, the interception of the user's command to “send” the email described above could equally be an interception of the user's command to “save” a document in a document authoring program, such as Microsoft Word. As with the email example, the user is presented a list of suggested filing locations drawn from database server 15. Once a filing location is selected by the user, user computer 13 sends the document to application server 16 for desegregation and submission of each part (including the selected filing location; i.e. the “project” field) to database server 15 for storage.

In one embodiment of the present invention, each filing location is represented to the user as a “public folder” in the email client program referred to above (in this case, Microsoft Outlook). Importantly, though, each document filed to that filing location and shown to the user in the public folder is in fact stored, in its deconstructed form, on database server 15. The reference to each document is in fact merely a link to the document. This is the technique of “masquerading” referred to above, enabling documents to be stored in deconstructed form on network-connected database server 15.

If the user selects a document in a filing location's public folder, such as an email, and clicks the user interface's “open” button, the “open” command is sent to application server 16, which queries the database for that document, reconstructs it, communicates it back to user computer 13 which presents it on the user interface.

By deconstructing documents and storing them on database server 15, the present invention takes advantage of the query functionality made available by standard database programs. Typically, databases can be queried using ANSI SQL commands. ANSI SQL is a powerful query language that allows application server 16, on behalf of user on user computer 13, to query database 15 for all documents of type “fax”, sent by participant “x” to participant “y” on “2/2/ox”, for example.

Deconstruction of each document into its constituent parts, and storage on database server 15, also enables the assignment of the implicit security permissions described earlier in this specification. For example, stored in database server 15, and associated with the record of email “1” as fields, are the names of each recipient of email “1”, and the sender of email “1”. If email “1” was to be published on an extranet, for example, application server 16 could query database server 15 for the recipients and sender of email “1” (referred to in this example as “relevant participants”). Based on this information, application server 16 could export email “1” to the webroot directory of a web server, and assign READ permissions for that copy of email “1” to each relevant participant. The techniques by which the extranet web server restricts READ access to only those participants with READ permission are well-known.

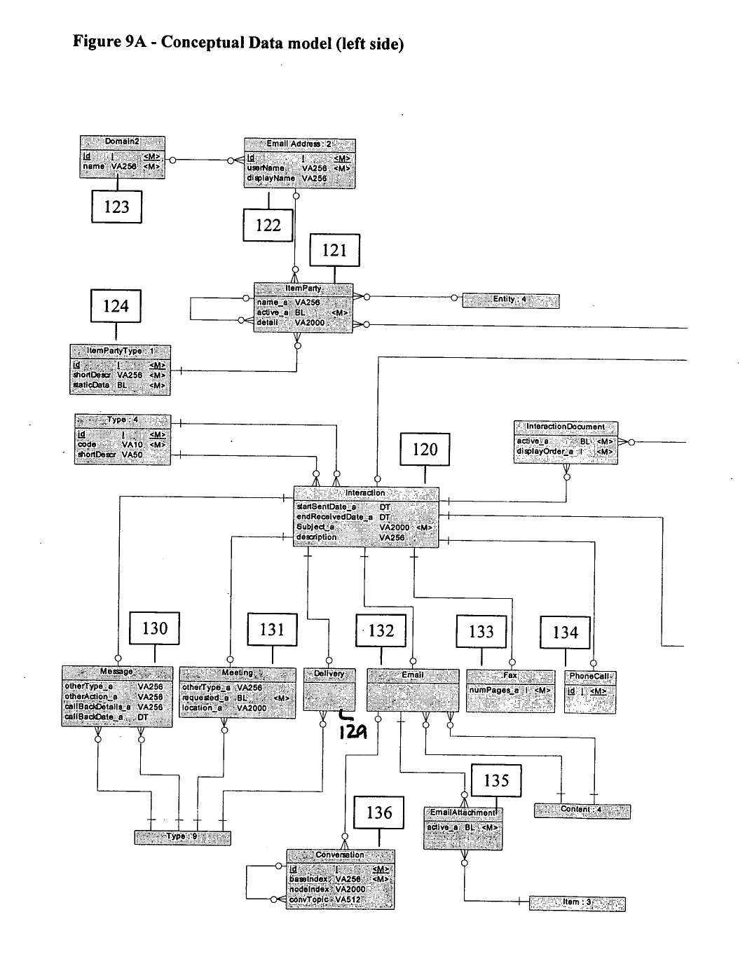

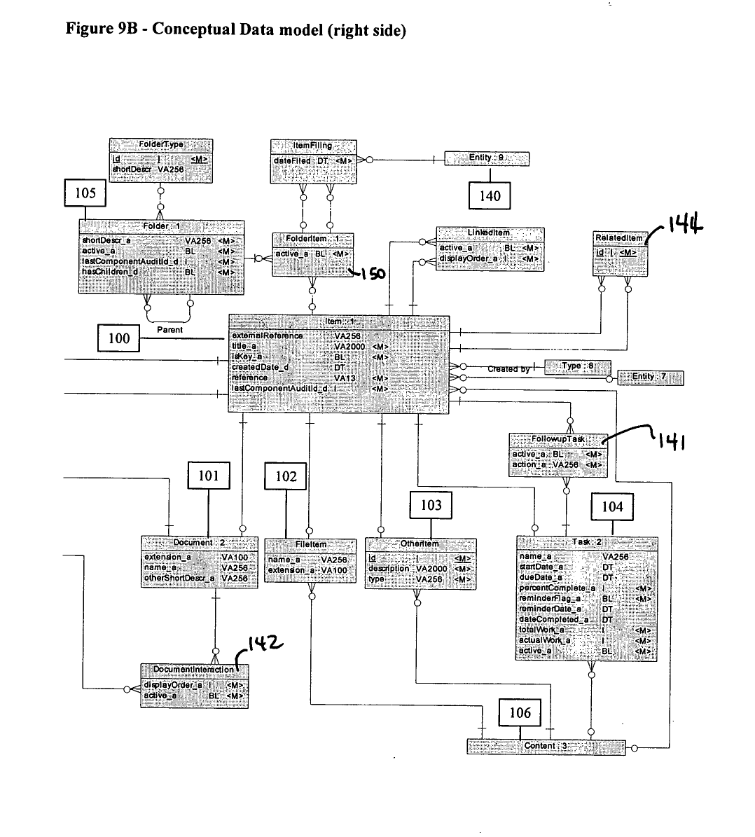

FIGS. 9A and 9B represent a conceptual data model, in an embodiment of the present invention, showing the relationship between the classes, and the properties within those classes, associated with items.

These data models are self-descriptive.

This model represents objects in the system, including their properties and the relationships between them.

In the representative embodiment, the three, central objects of the system, to which all other objects and relationships connect, are Item 100, Folder 105 and Entity 140.

Items represent the individual pieces of information that are filed into the system (such as Emails 132 or Documents 101), Folders 105 represent the locations to which they are filed, and Entities 140 represent any individuals or groups either associated with, or acting on the filed information.

There are many types of Items that can be filed into the system. The Item 100 object represents the common information between all Item types. Additional objects, subordinate to Item, represent information unique to a specific Item type. Thus, an individual piece of information filed into the system is represented by an Item object plus one or more subordinate objects describing its particular details.

There are five broad types of Item: FileItems 102, Documents 101, Tasks 104, Interactions 120 and OtherItem 103 types. FileItems are used to represent static, point-in-time information that has been added from an external file system, such as email attachments. FileItems cannot be edited once they have been filed.

Document 101 objects represent dynamic information for which editing is managed. Documents are either created directly in the system, or imported from an external document management system.

Tasks 104 represent activities which have a start and end date and which track the status of the activity.

Interactions 120 represent all types of communication between two or more individuals or groups. Items of type Interaction are represented by six sub-types: Messages 130, Meetings 131, Deliveries 129, Emails 132, Faxes 133, and PhoneCalls 134.

All types of information that do not fall into one of the first four categories are stored as OtherItems.

In the real world, information often exists as a collection of closely related pieces, and the system models this by providing a number of specific, inter-item relationships. Any Item can be related to an Email 132 as an EmailAttachment 135. Emails that are replies to other Emails are linked as a Conversation 136. A Task can be related to any Item as a FollowupTask 141. Any Document can be associated with an Interaction 120 as an InteractionDocument 142, such as the file notes for a meeting, or the body of a fax.

Loose collections of information, without any particular relationship, are also modeled by allowing any Item to be related to any other Item as a RelatedItem 144.

The unstructured component of an Item 100 is its Content 106. This is the core information or text that is being stored, such as the body of an Email 132 or the text of a Document 101 or FileItem 102. The system recognises that despite the type of Item 100 involved and its particular meta data (such as title or creation date), this content can often be same between two or more different Items, even of different types.

Thus, the Content 106 object stores a unique copy of each piece of information in the system, regardless of which Item (or Items) it is attached to. Once stored, Content 106 cannot be changed, so that if an Item 100 is edited, a new, unique Content 106 object is created and linked to that Item 100. This allows for efficiencies when multiple copies of the same information is filed to the system.

Item Parties and Entities

A common aspect of all types of Items 100 is that a number of parties 121 can be associated with them in a range of different ways. For example, an Email 132 has a sender and one or more recipients, a Document 101 can have a number of authors, a Meeting 131 can have a convener and many participants, a delivery is made from one party to another, etc.

Any party associated with an Item 100 is modeled as an ItemParty 121. Each ItemParty has a type 124 (sender, to, CC, author, etc.), and depending on the type of Item 100 and the available information, can optionally be linked to a defined Entity 140 in the system, an EmailAddress 122, or both.

Entities 140 store name and address information for individuals, organizations or their members, and the network of relationships exist between them. Entities 140 can also be associated with EmailAddresses 122 as well as UserAccounts (not shown), which represent actual users of the system.

Folders and Filing

Items 100 can be filed in one or more Folders 105, and the relationship between each Item and it's Folder is represented by a FolderItem 150.

Folders 105 are means of modeling any hierarchical system of grouping or categorization, with each Folder able to be have any other Folder as its parent.

Items can be filed in any number of Folders, and the act of filing is modeled by the ItemFiling object, which records details of the filing action (adding, removing, moving, copying) and the Entity 140 who performed that action.

Certain folders can be flagged as having a specific type, and in addition to filing actions by Entities, the system will automatically file certain types of Items into certain types of Folders.

With implicit access to be used in an extranet environment, refer to ItemParties 121. Referencing FIG. 9: Items 100 (e.g., an Email), has associated ItemParties 121 (to, cc, bcc) etc. An ItemParty 121 can be related by an EmailAddress 122 which belongs to a particular Entity 140 at a particular point in time. The strong relationships (e.g., email recipients) are effective dated so that the present invention knows which Individuals have access to which Items.

The present invention handles cases of email groups—modeled as Entity Groups relating other Entities (and effective dated to know what the membership was at a particular point in time); and items contained by another item e.g.,: a document attached to an email infers that the recipients of the email would have access to the document; or a letter (Interaction) infers access to the document.

The present invention has been described in the context of a law firm's electronic files, but is not so limited. For example, an accounting firm could use the invention to manage and organize communications and documents relating to services provided to the accounting firm's clients. A bank could use the invention to organize all the documentation and communications relating to the bank's loan transactions. A sales team could use the invention to organize information relating to sales of particular goods or services. A government department could use the invention to organize and manage documents and correspondence relating to the issuing of licenses or permits. An HR department in an organization could use the invention to manage personnel files. A company's board could use the invention to efficiently store and share communications and other documentation.

The present invention is not limited by the examples and representative embodiment disclosed herein. While the present invention had been particularly shown and described with reference to representative embodiments, it will be understood by those skilled in the art that various changes in form, environment and detail may be made without departing from the spirit and scope of the invention.

In this specification, where a document, act or item of knowledge is referred to or discussed, this reference or discussion is not an admission that the document, act or item of knowledge or any combination thereof was at the priority date publicly available, known to the public, part of the common general knowledge, or known to be relevant to an attempt to solve any problem with which this specification is concerned.

What is claimed is:

1. A computer-implemented electronic automated file management system for email messages, where a subset of email messages include email attachments, comprising:
a computer network;
a computer, coupled to the computer network which can send, receive, edit and access electronic documents using an email client program;
an email server, coupled to the computer network, for storing email messages;
a database server, coupled to the computer network, for storing email messages and email attachments, and allowing the searching and retrieval of email messages and email attachments; and
an event server, coupled to the computer network, that intercepts a command to send an email message and automatically causes a plurality of suggested filing locations to be presented to the computer in conjunction with the sending of the email message such that at least one suggested filing location can be selected;
wherein, after an email message has been sent by the email server, that email message is stored in the database server with the selected associated filing location information, and
wherein the email client program at least comprises one link to the database server for each email message, said at least one link presented in folders representing the selected filing locations.

2. The computer-implemented electronic automated file management system of claim 1 wherein the email client program does not store copies of email messages sent and filed by the user.

3. The computer-implemented electronic automated file management system of claim 1 wherein each email attachment for an email message is stored in the database server separate from the email message.

4. The computer-implemented electronic automated file management system of claim 1 wherein suggested filing locations to be presented at the computer are for email messages received by the computer.

5. The computer-implemented electronic automated file management system of claim 1 wherein a flag is presented next to an email message at the computer when that email message has been filed in the database server by another computer.

6. The computer-implemented electronic automated file management system of claim 1 wherein each email message stored in the database server includes at least one permission for the email message.

7. The computer-implemented electronic automated file management system of claim 1 wherein each email message stored in the database server includes at least one permission for the email message that is automatically set based upon a predetermined security model.

8. The computer-implemented electronic automated file management system of claim 1 wherein each email message stored in the database server is accessible by other computers over a connection and each email message includes at least one permission for the email message relating to access permissions for said other computers.

9. The computer-implemented electronic automated file management system of claim 1 wherein each email message stored in the database server is accessible by other computers over an extranet connection and each email message includes a list of permissions for the email message relating to access permissions for said other computers that are automatically set based upon a predetermined security model.

10. The computer-implemented electronic automated file management system of claim 1 wherein each email attachment can be accessed independently of the email message.

11. A computer-implemented electronic automated file management system for email messages, comprising:
a computer network, including connections to remote computer networks;
a computer, coupled to the computer network, which can send, receive, edit and access email messages using an email client program;
an email server, coupled to the computer network, for storing email messages and for sending email messages to other email servers;
a database server, coupled to the computer network, for storing email messages, and allowing the searching and retrieval of email messages, each email message stored in the database server including a list of permissions for the email message;
an event server, coupled to the computer network, that intercepts a command to send an email message and automatically causes a plurality of suggested filing locations to be presented to the computer in conjunction with the sending of the email message such that the computer can select at least one suggested filing location;
means for automatically setting the list of permissions for each email message based upon a predetermined security model; and
means for allowing external computers to access email messages in the database server in accordance with the list of permissions, such access being provided from the remote computer network,
wherein, after an email message has been sent by the email server, that email message is stored in the database server with associated filing location information as selected by the computer.

12. The computer-implemented electronic automated file management system of claim 11 wherein the email client program does not store copies of email messages sent and filed by the computer.

13. The computer-implemented electronic automated file management system of claim 11 wherein the email client program comprises at least one link to the database server for each sent email message, said at least one link being presented in folders representing the selected filing locations.

14. The computer-implemented electronic automated file management system of claim 11 wherein suggested filing locations to be presented to the computer are for email messages received by the computer.

15. The computer-implemented electronic automated file management system of claim 11 wherein a flag is presented next to an email message when that email message has been filed in the database server by another computer.

16. The computer-implemented electronic automated file management system of claim 11 further comprising means for modeling the structure of an email message.

17. The computer-implemented electronic automated file management system of claim 11 further comprising means for prompting an email message upon the occurrence of a predetermined trigger event.

18. The computer-implemented electronic automated file management system of claim 11 further comprising means to allow the marking of an email message as being personal prior to sending, which causes the event server to be deactivated for that email message.

19. A computer-implemented electronic automated file management system for electronic documents, comprising:
a computer network;
a computer, coupled to the computer network which can be used to edit and access documents using a client program;
a document server, coupled to the computer network, for storing documents;
a database server, coupled to the computer network, for storing documents, and allowing for the searching and retrieval of documents; and
an event server, coupled to the computer network, that intercepts a predetermined command and automatically causes a plurality of suggested filing locations to be presented to the computer such that it is used to select at least one suggested filing location,
whereby that document is stored in the database server with the associated selected filing location information, and
wherein the client program comprises at least one link to the database server for each filed document said at least one link being presented in folders representing filing locations.

20. A computer-implemented electronic automated file management system for electronic documents, comprising:
a computer network, including connections to remote computer networks;
a user computer, coupled to the computer network, for editing and accessing documents;
a document server, coupled to the computer network, for storing documents;
a database server, coupled to the computer network, for storing documents, and allowing the searching and retrieval of documents, each document stored in the database server including a list of permissions for the document;
an event server, coupled to the computer network, that intercepts a predetermined command and automatically causes a plurality of suggested filing locations to be presented, such that at least one suggested filing location can be selected;
means for automatically setting a permission for each document based upon a predetermined security model; and
means for allowing external users to access documents in the database server in accordance with the list of permissions, such access being provided from a remote computer network.

21. A method for electronically filing an email message, the method comprising the steps of:
associating a plurality of filing locations with a user, each filing location being a logical location on a server;
creating the email message using an email client program having a user interface;
allowing through the user interface a command to be selected and sent;
automatically providing a list of suggested filing locations for the email message, the items in the list of suggested filing locations selected by a program based on the filing locations associated with the user, filing locations to which the user has recently filed documents, and filing locations recently used by the recipient of the email message;
allowing the selection of one of the suggested filing locations; and
if one of the suggested filing locations is selected, then sending the email message to the recipient and filing the sent email message in the selected filing location.

22. The method of claim 21 further comprising the steps of:
presenting a list of all filing locations associated with the user; and
allowing the selection of at least one of said filing locations.

23. The method of claim 21 wherein the step of automatically providing a list of suggested filing locations for the email message, further comprises the step of assigning weights to determine an ordered list of suggested filing locations.

24. The method of claim 21 wherein the step of automatically providing a list of suggested filing locations for the email message, further comprises the steps of assigning weights to determine the suggested filing location are most likely to be selected.

25. The method of claim 22 further comprising the step of allowing an email message to be sent without selecting a filing location.

26. The method of claim 21 further comprising the steps of:
presenting a list of all filing locations associated with a user;
allowing the selection of more than one of said filing locations; and
sending an email message and filing the sent email message in each selected filing location.

27. A method for electronically filing an email message, comprising the steps of:
associating a plurality of filing locations with a user, each filing location being a logical location on a server;
creating the email message to a recipient using an email client program;
selecting and sending a command;
automatically providing suggested filing locations for the email message, the items in the list of suggested filing locations selected by a server program based on the filing locations associated with the user, filing locations to which the user has recently filed documents, and the filing locations recently used by the recipient of the email message;
presenting a list of all filing locations associated with the user;
allowing the selection of at least one of said filing locations and suggested filing locations; and
sending the email message to the recipient and filing the sent email message in the at least one said selected filing location.

28. The method of claim 27 further comprising the steps of:
automatically setting a permission for each email message based upon a predetermined security model; and
allowing external users to access email messages in accordance with the list of permissions, such access being provided from a remote computer network.

29. The method of claim 28, further comprising the step of assigning weights to determine an ordered list of suggested filing locations.

30. The method of claim 27 further comprising the step of allowing an email message to be sent without selecting a filing location.

31. Software for electronically filing an email message, the software embodied on a computer readable medium and, when executed by a computer, operable to,
associate a plurality of filing locations with a user, each filing location being a logical location on a server;
create the email message to a recipient using an email client program;
select and send a command;
automatically provide suggested filing locations for the email message, the items in the list of suggested filing locations selected by a server program based on the filing locations associated with the user, filing locations to which the user has recently filed documents, and the filing locations recently used by the recipient of the email message;
present a list of all filing locations associated with the user; allow the selection of at least one of said filing locations and suggested filing locations; and
send the email message to the recipient and file the sent email message in the at least one said selected filing location.
